(19) United States
(12) Patent Application Publication
(10) Pub. No.: US 2025/0018651 A1
(43) Pub. Date: Jan. 16, 2025

(54) REDUCED POROSITY 3D PRINTED COMPOSITES

(71) Applicant: UT-Battelle, LLC, Oak Ridge, TN (US)

(72) Inventors: Vipin Kumar, Knoxville, TN (US); Wim Bras, Oak Ridge, TN (US); Vlastimil Kunc, Knoxville, TN (US); Chad Duty, Loudon, TN (US); Frye Mattingly, Knoxville, TN (US)

(21) Appl. No.: 18/771,173

(22) Filed: Jul. 12, 2024

Related U.S. Application Data
(60) Provisional application No. 63/526,506, filed on Jul. 13, 2023.

(51) Int. Cl. B29C 64/329; B29C 64/118; B29C 64/295; B29C 64/343; B29C 64/393; B29K 55/02; B29K 105/08; B29K 307/04; B29K 309/08; B33Y 10/00; B33Y 30/00; B33Y 50/02

(52) U.S. Cl. CPC B29C 64/329; B29C 64/118; B29C 64/295; B29C 64/343; B29C 64/393; B33Y 10/00; B33Y 30/00; B33Y 50/02; B29K 2055/02; B29K 2105/08; B29K 2307/04; B29K 2309/08

(57) ABSTRACT

A method of additively manufacturing reduced porosity composites is provided. The method includes the step of providing an additive manufacturing printer including a feed hopper. The feed hopper includes a first valve disposed proximate a feed inlet in a closed position and a second valve disposed proximate a chamber opening in an open position. The feed hopper defines a first chamber and a second chamber in selective fluid communication via the chamber opening. The method includes applying a rough vacuum to the first and second chamber and feeding feedstock into the feed hopper. The first valve is opened and the second valve is closed. The first valve is closed and the second valve is opened. The feedstock is allowed to exit the feed hopper and is heated to give a heated printing material, which is extruded. An associated feed hopper is also provided.

### CROSS-REFERENCE TO RELATED APPLICATIONS

This application claims the benefit of U.S. Provisional Application 63/526,506, filed Jul. 13, 2023, the disclosure of which is hereby incorporated by reference.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to a reduced porosity 3D printed composite and associated methods.

### BACKGROUND OF THE INVENTION

Large-scale polymer additive manufacturing has many advantages including reduced cost, reduced waste, and ability to manufacture complex structures. However, large-scale polymer additive manufacturing still has serious drawbacks including high porosity levels and relatively low mechanical properties across the direction of deposition, generally the Z-direction. The porosity of big area additive manufacturing (BAAM) produced parts is significantly high between the interface of printed beads (in a diamond shape) and is referred to as macro-porosity. The porosity present within printed beads is generally referred to as micro-porosity. Micro-porosity can range from 3-20% in a printed part and has a substantial impact on the mechanical properties of the printed part. The high porosity is caused by the heating of feedstock pellets to give the printed parts. During the extrusion of pellet-based feedstock, the air gets trapped within the feedstock and creates large porosity in the form of internal voids and pores in the printed structure. Increases in porosity of printed articles are also known in composite articles with carbon and glass fibers. Air voids tend to stick to the fiber's surface due to the surface tension in a hot molten matrix and, under high shear, are elongated in the material flow direction along the fiber's surface. The fibers in composites can act as pore nucleation zones.

Therefore, the need for development of a method and equipment to reduce the porosity in 3D printed composites remains.

### SUMMARY OF THE INVENTION

A method of additively manufacturing reduced porosity composites is provided. The method comprises the step of providing an additive manufacturing printer comprising a feed hopper, or a vacuum-assisted feed hopper. The feed hopper comprises a first hopper wall defining a feed inlet and a chamber opening. The feed hopper also comprises a second hopper wall contacting an outlet end of the first hopper wall. The second hopper wall also defines a feed outlet. The feed hopper comprises a vacuum lid, and the vacuum lid contacts a feed end of the first hopper wall. The feed hopper includes a first valve disposed proximate the feed inlet in a closed position. The feed hopper also comprises a second valve disposed proximate the chamber opening in an open position. The feed hopper includes a vacuum pump. The first hopper wall and the vacuum lid define a first chamber disposed proximate to a second chamber defined by the first hopper wall and the second hopper wall. The first chamber and the second chamber are in selective fluid communication via the chamber opening. The method includes applying a rough vacuum to the first chamber and the second chamber using the vacuum pump and feeding feedstock into the feed hopper of the additive manufacturing printer. The method includes opening the first valve and closing the second valve, thereby pulling feedstock into the first chamber from a feedstock source. The first valve is closed and the second valve is opened, thereby allowing feedstock from the first chamber to enter the second chamber and maintain a rough vacuum in the second chamber. The feedstock is allowed to exit the feed hopper via the feed outlet and is heated to give a heated printing material. The heated printing material is extruded out of the additive manufacturing printer.

A feed hopper (or vacuum-assisted feed hopper) for an extruder for the extrusion of low porosity additively manufactured composites is provided. The feed hopper comprises a first hopper wall. The first hopper wall defines a feed inlet and a chamber opening. The feed hopper also includes a second hopper wall. The second hopper wall contacts an outlet end of the first hopper wall and defines a feed outlet. The feed hopper includes a vacuum lid contacting a feed end of the first hopper wall and a vacuum pump. The feed hopper further comprises a first valve disposed proximate the feed inlet and a second valve disposed proximate the chamber opening. The first hopper wall and the vacuum lid define a first chamber. The first hopper wall and the second hopper wall define a second chamber. The first chamber and the second chamber are disposed proximate each other. The first chamber and the second chamber are in selective fluid communication via the chamber opening.

Another method of additively manufacturing reduced porosity composites is also provided. The method includes applying a rough vacuum to a first chamber and a second chamber defined by a feed hopper of an additive manufacturing printer. The feedstock is fed into the feed hopper of the additive manufacturing printer, and the feedstock is allowed to exit the feed hopper via the feed outlet. The feedstock is heated to give a heated printing material, and the heated printing material is extruded out of the additive manufacturing printer.

### BRIEF DESCRIPTION OF THE DRAWINGS

FIG. 1 is a schematic depiction of a conventional feed hopper for a single screw extruder with a conventional feed hopper using conventional methods.

FIG. 2 is a schematic depiction of a vacuum-assisted feed hopper for a single screw extruder with a vacuum applied to the feed hopper.

FIG. 3 is a graph of porosity as a function of the weight loading of carbon fiber in acrylonitrile butadiene styrene (ABS) for additive manufacture with and without the application of a vacuum to the feed hopper.

FIG. 4 is a graph of porosity as a function of the weight loading of glass fiber in ABS for additive manufacture with and without the application of a vacuum to the feed hopper.

FIG. 5A is a graph of porosity as a function of time out of a drying oven for covered 40 wt. % glass fiber ABS.

FIG. 5B is a graph of porosity as a function of time out of a drying oven for uncovered 40 wt. % glass fiber ABS.

### DETAILED DESCRIPTION OF THE CURRENT EMBODIMENTS

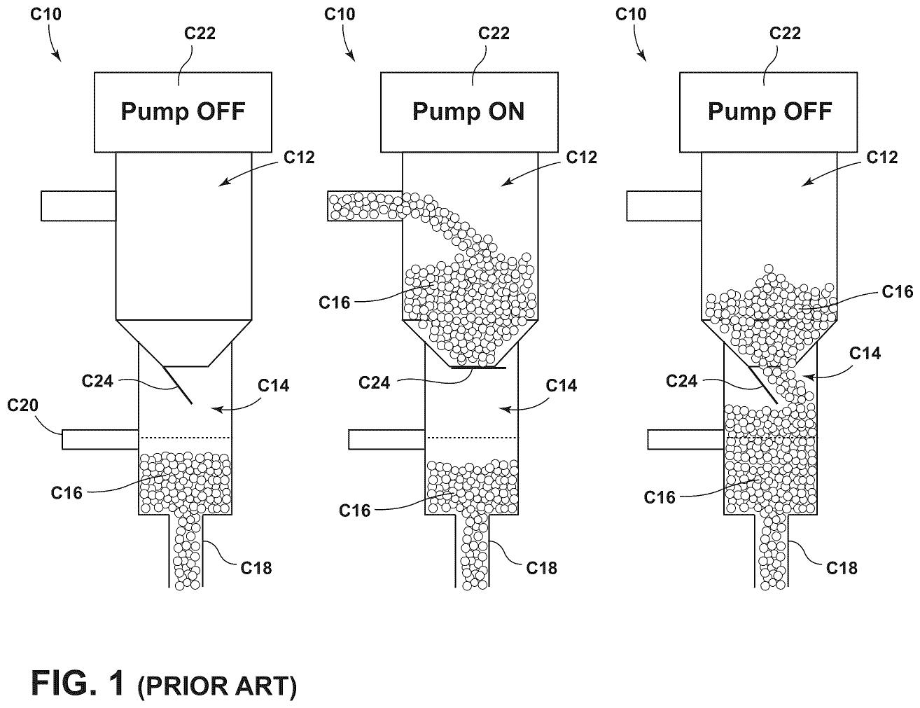

Referring now to FIG. 1, a conventional intermediate hopper design typical of large format additive manufacturing (LFAM) such as big area additive manufacturing (BAAM) is shown. Conventional systems have a two-stage, on-board feed hopper C10 that travels with the extruder during printing. Since conventional feed hoppers are mobile, the weight and size of the feed hoppers C10 are minimized. These conventional systems include an upper chamber C12 disposed above a lower chamber C14. In the rightmost system depicted in FIG. 1, the pellets C16 are shown in a depleted state in the lower chamber C14, which is at ambient pressure. As the pellets are gravity fed into the extruder through a feed tube C18 at the bottom of the feed hopper C10 the pellet level falls below a light sensor C20 and triggers a vacuum pump C22 to turn on as depicted in the central system depicted in FIG. 1. As the pressure in the upper chamber C12 reduces a flap C24 disposed between the upper C12 and lower chambers C14 is pulled closed and a rough vacuum is produced in the upper chamber C12 that pulls a new supply of pellets from a larger external hopper (e.g., a drying tower). Once an appropriate amount of pellets C16 are supplied to the upper chamber C12 the pump C22 turns off (as depicted in the rightmost system shown in FIG. 1) and the pellets fall into the lower chamber.

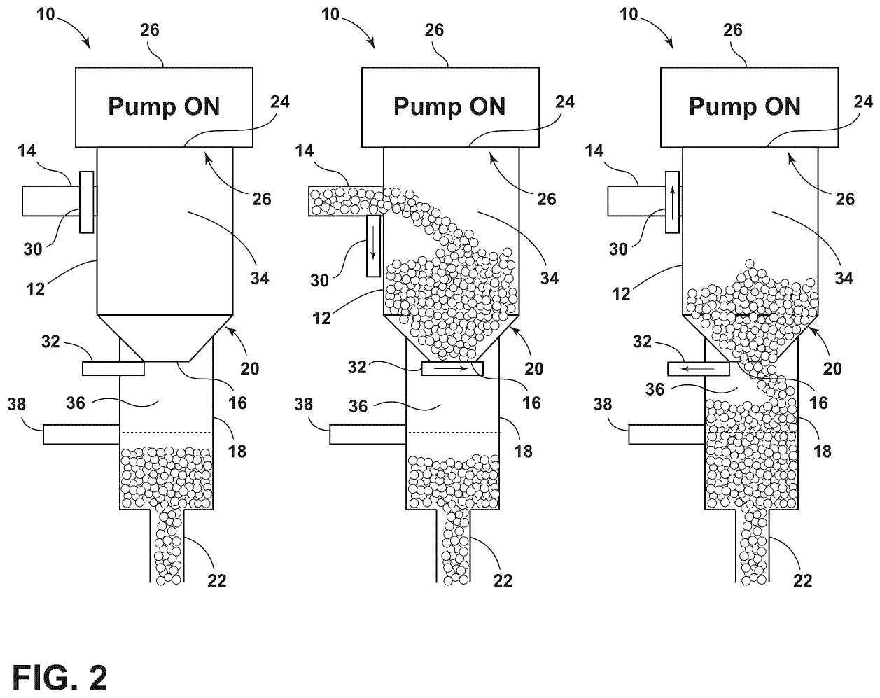

Referring now to FIG. 2, a feed hopper 10 for an extruder for the extrusion of low porosity additively manufactured composites is provided. The feed hopper 10 comprises a first hopper wall 12. The first hopper wall 12 defines a feed inlet 14 and a chamber opening 16. The feed hopper 10 also includes a second hopper wall 18. The second hopper wall 18 contacts an outlet end 20 of the first hopper wall 12 and defines a feed outlet 22. The feed hopper 10 includes a vacuum lid 24 contacting a feed end 26 of the first hopper wall 12 and a vacuum pump 28. The feed hopper 10 further comprises a first valve 30 disposed proximate the feed inlet 14 and a second valve 32 disposed proximate the chamber opening 16. The first hopper wall 12 and the vacuum lid 24 define a first chamber 34. The first hopper wall 12 and the second hopper wall 18 define a second chamber. The first chamber 34 and the second chamber 36 are disposed proximate each other. The first chamber 34 and the second chamber 36 are in selective fluid communication via the chamber opening 16.

The feed hopper 10 may further comprise a sensor 38. The sensor 38 is generally disposed proximate the second hopper wall 18. The sensor 38 is configured to detect a level of feedstock. In some embodiments, the sensor 38 is a light sensor 38.

The feed hopper 10 may be integrated into an additive manufacturing printer. In certain embodiments, the additive manufacturing printer is a single screw extruder. The single screw extruder generally comprises the feed hopper 10 and a screw barrel disposed adjacent the feed outlet 22. The screw barrel houses a screw. A die is connected to an extrusion end of the screw barrel by an adaptor. The single screw extruder further includes a drive system operatively connected with the screw and configured to rate the screw at a screw speed.

A method of additively manufacturing reduced porosity composites (“the method”) is also provided. The method comprises the step of providing an additive manufacturing printer comprising a feed hopper 10. The feed hopper 10 comprises a first hopper wall 12 defining a feed inlet 14 and a chamber opening 16. The feed hopper 10 also comprises a second hopper wall 18 contacting an outlet end 20 of the first hopper wall 12. The second hopper wall 18 also defines a feed outlet 22. The feed hopper 10 comprises a vacuum lid 24, and the vacuum lid 24 contacts a feed end 26 of the first hopper wall 12. The feed hopper 10 includes a first valve 30 disposed proximate the feed inlet 14 in a closed position. The feed hopper 10 also comprises a second valve 32 disposed proximate the chamber opening 16 in an open position. The feed hopper 10 includes a vacuum pump 28. The first hopper wall 12 and the vacuum lid 24 define a first chamber 34 disposed proximate to a second chamber 36 defined by the first hopper wall 12 and the second hopper wall 18. The first chamber 34 and the second chamber are in selective fluid communication via the chamber opening 16. The method includes applying a rough vacuum to the first chamber 34 and the second chamber 36 using the vacuum pump 28 and feeding feedstock into the feed hopper 10 of the additive manufacturing printer. The method includes opening the first valve 30 and closing the second valve 32, thereby pulling feedstock into the first chamber 34 from a feedstock source. The first valve 30 is closed and the second valve 32 is opened, thereby allowing feedstock from the first chamber 34 to enter the second chamber 36 and maintain a rough vacuum in the second chamber. The feedstock is allowed to exit the feed hopper 10 via the feed outlet 22 and is heated to give a heated printing material. The heated printing material is extruded out of the additive manufacturing printer.

The method generally allows for the continuous feed of feedstock for printing. Specifically, the inclusion of the second valve 32 in the feed hopper 10 facilitates the selective fluid communication of the first chamber 34 with the second chamber 36. This selective fluid communication allows for the first chamber 34 and the second chamber 36 to have the same or different pressures and allows for a rough vacuum to be applied to the second chamber 36 while feedstock is fed into the first chamber 34. While the feedstock is fed through the feed inlet 14 into the first chamber 34, feedstock under a rough vacuum leaves the second chamber 36 via the feed outlet 22. Once the first chamber 34 includes sufficient feedstock the first valve 30 closes and the second valve 32 opens, restoring fluid communication between the first chamber 34 and the second chamber 36 such that pressure is equilibrated between the first chamber 34 and the second chamber 36. The feedstock exits the first chamber 34 via the chamber outlet 16 and enters the second chamber 36. The second valve 32 is then closed and the first valve 30 is opened, allowing for the introduction of more feedstock into the feed hopper 10. This process is repeated until printing is complete. Notably, this allows for the continuous introduction and printing of feedstock by allowing the introduction of feedstock into the first chamber 34 while feedstock under rough vacuum simultaneously exits the second chamber 36.

The method may further include a step of drying the feedstock at a drying temperature for a drying time. The step of drying the feedstock occurs less than 6 hours, alternatively less than 3 hours, alternatively less than 1 hours, alternatively less than 30 minutes, before the step of extruding the feedstock out of the additive manufacturing printer. The drying temperature is a temperature of between 40 to 120° C., alternatively 70 to 100° C., alternatively 80 to 90° C., or alternatively about 85° C. The drying time is between 2 and 12 hours, alternatively 3 to 5 hours, or alternatively 6 to 10 hours.

The feedstock generally comprises a thermoplastic and can be reinforced or unreinforced. For example, the feedstock may comprise polylactic acid (PLA), polyethylene terephthalate glycol (PETG), acrylonitrile styrene acrylate (ASA), thermoplastic elastomer (TPE), polyamide (Nylon), polycarbonate (PC), or a combination thereof. In specific embodiments, the feedstock comprises acrylonitrile butadiene styrene (ABS). The feedstock can further include a reinforcing fiber. In specific embodiments, the reinforcing fiber comprises a carbon fiber or a glass fiber. In embodiments where the reinforcing fiber comprises a carbon fiber the feedstock comprises the carbon fiber in an amount of from 0.01 to 25 wt. %, alternatively 0.1 to 20 wt. %, alternatively 0.1 to 10 wt. %, alternatively 10 to 20 wt. %, alternatively 5 to 15 wt. %. In embodiments where the reinforcing fiber comprises a glass fiber the feed stock comprises the carbon fiber in an amount of from 0.01 to 45 wt. %, alternatively 0.1 to 40 wt. %, alternatively 0.1 to 20 wt. %, alternatively 20 to 40 wt. %, alternatively 10 to 30 wt. %.

In some embodiments, the step of heating the feedstock further comprises displacing the feedstock through multiple temperature control zones. In specific embodiments, the feedstock is displaced through four temperature control zones. The four temperature control zones consist of: a feed heating section having a feed temperature; a mixing section having a mixing temperature; a metering section having a metering temperature; and an exit section having an exit temperature. The feed temperature can be a temperature of between 150 to 210° C., alternatively 170 to 190° C.; the mixing temperature can be a temperature of between 190 to 250° C., alternatively 210 to 230° C.; the metering temperature can be a temperature of between 210 to 270° C., alternatively 230 to 250° C.; and the exit temperature is a temperature of between 210 to 270° C., alternatively 230 to 250° C.

Generally, a rough vacuum is defined as any pressure lower than 760 Torr (i.e., a vacuum of more than −10 (i.e., a pressure of 750 Torr) to −760 (i.e., a pressure of 0 Torr or a perfect vacuum). The rough vacuum may be between −200 to −760 Torr (a pressure of 560 to 0 Torr), alternatively −250 to −400 Torr (a pressure of 510 to 360 Torr). The rough vacuum may be established using the vacuum pump 28.

The additive manufacturing printer can be a single screw extruder. The single screw extruder can be operated at a screw speed of between 20 to 140 rpm, alternatively 50 to 120 rpm, alternatively 80 to 120 rpm, alternatively about 100 rpm, or at a screw speed of between 200 to 1000 rpm, alternatively 300 to 500 rpm, alternatively 700 to 900 rpm, alternatively 350 to 850 rpm.

The method may be used to manufacture an additively manufactured article. The article can have a porosity % of less than 25%, alternatively less than 15%, alternatively less than 10%, alternatively less than 5%, alternatively less than 2%, alternatively about 1%.

### EXAMPLE

A Randcastle single-screw extruder was used with a vertically-oriented single screw extruder with a feed hopper sitting directly above a 127 mm diameter screw. The screw section is 60.96 cm long and has four thermal zones that were set to 180° C. in a feed section, 220° C. in a mixing section, 240° C. in a metering section, and 240° C. in an exit manifold. The manifold at an end of the screw turns the feedstock 90 degrees to exit horizontally through a 63.5 mm diameter nozzle. The screw rotational speed was varied from 40 to 110 rpm in increments of 10 rpm. Most samples were collected at a constant screw rotational speed of 100 rpm. An aluminum lid with a vacuum port and a pressure gauge was placed over the feed hopper to apply a vacuum to the feed hopper.

Pellets (60 to 80 grams per sample set) were loaded into the feed hopper. The pellets were extruded through the Randcastle single-screw extruder until consistent extrusion is established under ambient conditions. The vacuum lid was put in place on the feed hopper and a vacuum pump (ULVAC model GLD-135C, 135-162 L/min) was turned on, and a rough vacuum of −25 in Hg gauge pressure (−646 Torr or an 85% vacuum) was achieved in the feed hopper within 5 to 10 seconds of the pump being activated. The vacuum pressure is held steady for contact extrusion, but briefly fluctuates by up to 3 in Hg if extrusion was stopped and restarted.

Extruded samples were gently supported with tongs to maintain horizontal alignment with the extruder exit and to partially compensate for the corkscrew curling the free hanging bead as it exited the nozzle. Beads were then trimmed at the nozzle interface with a spatula into 10 to 20 in (25 to 50 cm) sections and transitioned to a tray for cooling under ambient conditions. A visual inspection of the bead shape, quality, and color were used to roughly determine when steady state had been reached. Beads printed using conventional, non-vacuum methods demonstrate sharkskinning and die swelling. The beads printed using the vacuum method and feed hopper were generally smooth and of even diameter.

Three material sources were used to evaluate the effect on porosity due to increasing the amount of fiber reinforcement and changing the type of reinforcing fiber. All materials were procured in pellet form. The first material source was unreinforced acrylonitrile butadiene styrene (ABS) (“neat ABS”) supplied by TechmerPM. The second material source was 20 wt. % carbon fiber ABS and 40 wt. % glass fiber ABS, also supplied by TechmerPM. To vary the reinforcement content the reinforced materials were down-blended in pelletized from with the neat ABS. Prior to extrusion, the materials were dried at 80° C. for at least 8 hours. Some samples were left in a container (covered and uncovered) on the benchtop at ambient conditions (22° C., 50 to 65% relative humidity) for up to 6 hours. A series of experiments were conducted varying the fiber used in the ABS pellets, the weight loading of the fiber used in the ABS pellets, the method of drying the ABS pellets, and the time between drying and printing. The following examples were conducted using the Randcastle single-screw extruder.

Porosity of the extruded samples were evaluated using a volume-based Archimedes technique. Samples were cut into roughly 1 inch (2 to 3 cm) long segments, labeled sequentially, and measured individually. Each measurement recorded represents the average and standard deviation of at least five to seven measurements of adjacent segments from a single extruded bead. The process for determining the porosity of the material involves measuring the dry weight of the sample as well as the weight once submerged under water. Density of the sample was then determined by the change in weight due to buoyancy, and the porosity was determined by comparing the measured density against fully dense control sample made by injection molding. For samples where the tested fiber loading had been down-blended to a nonstandard value the control density was calculated through linear interpolation between the densities of molded bars that were at typical maximum fiber loading, and another made of neat ABS. The scale used for these measurements was a Mettler Toledo Excellence Level along with an XS series Analytical Balance.

The Archimedes technique measures an average porosity throughout the volume of the extruded sample. In cases where the external roughness was severe, such as bad shark skinning from an undried or non-vacuum sample, a hand file was run over the surface to remove the most significant roughness. The porosity of extrude samples was also investigated using small angle x-ray scattering (SAXS). Since smaller porosity (nm-scale) cannot be investigated using optical microscopy SAXS was utilized to evaluate the effect of the vacuum feed hopper on pores below 300 nm in diameter (the upper limit of SAXS sensitivity). The presence of smaller diameter pores in the printed sample are believed to result from either thermal degradation or outgassing of dissolved gasses since degassing likely occurs near the end of the extrusion process where the temperature was high, and the pressure change was greatest. Pores that formed earlier in the extrusion process due to moisture or entrapped air coalesce and grow into larger pores during the printing process. The number of smaller pores was unaffected by the vacuum feed hopper.

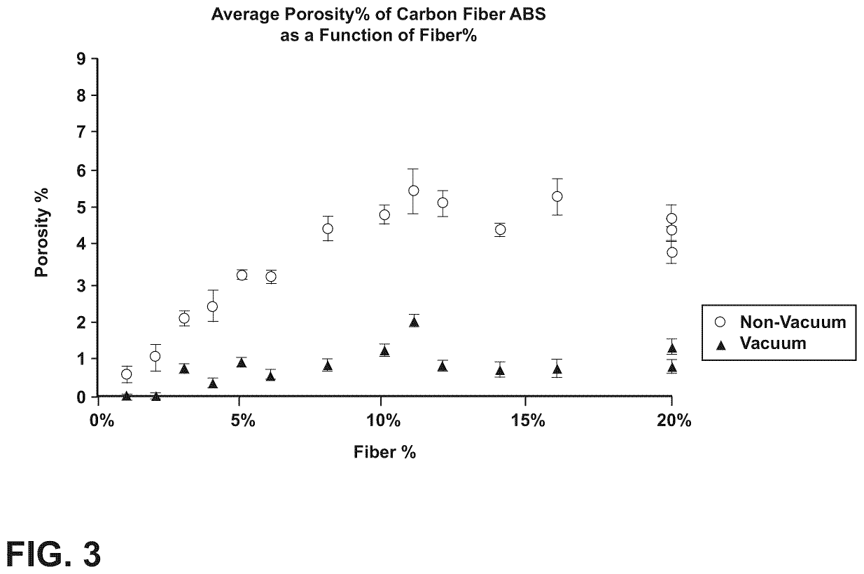

Referring now to FIG. 3, porosity of printed carbon fiber-ABS pellets is plotted as a function of fiber weight % of the carbon fiber-ABS feedstock. For conventional hopper systems using conventional methods, the porosity of a carbon fiber reinforced sample increase from less than 1 wt. % to about 5 wt. % as the fiber content increases from 0 wt. % to 10 wt. %, and then holds constant (4 wt. % to 5 wt. %) as the fiber contends continues to increase to 20 wt. %. In contrast, the vacuum hopper method maintains porosity below 2%, and in certain embodiments less than 1%, across the full range of carbon fiber contents.

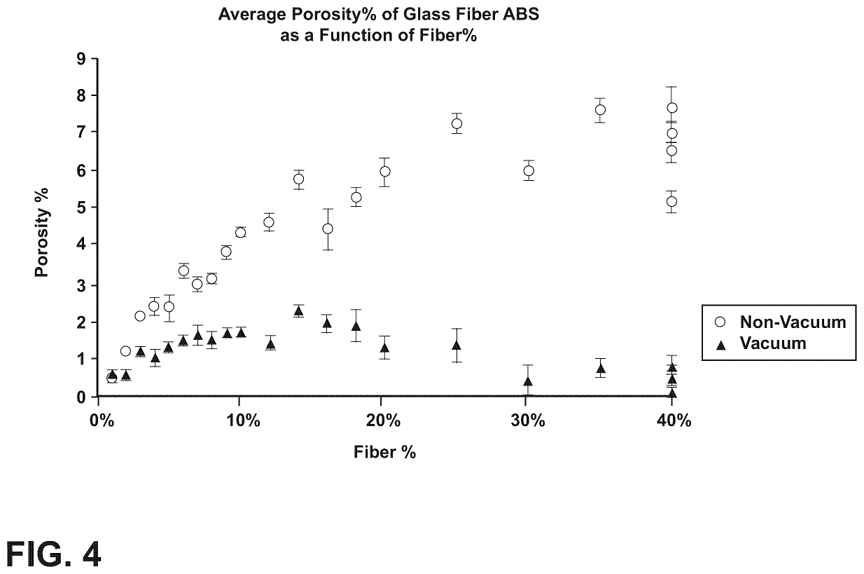

Referring now to FIG. 4, porosity of printed glass fiber-ABS pellets is plotted as a function of fiber weight % of the carbon fiber-ABS feedstock. FIG. 4 shows similar trends of porosity relative to glass fiber weight loading of glass fiber-ABS pellets as porosity relative to carbon fiber weight loading of carbon fiber-ABS pellets. The porosity increased to about 7% before stabilizing with the conventional feed hopper using conventional methods. However, using the vacuum feed hopper and method maintained porosity of 1 to 2% across the full range of glass fiber fiber contents tested. Without seeking to be bound by any theory, it is believed that porosity increases with fiber content because increased fiber increases pore nucleation points, and therefore fiber-vapor interfaces, but then eventually saturates such that a marginal increase in fiber content has minimal impact on porosity.

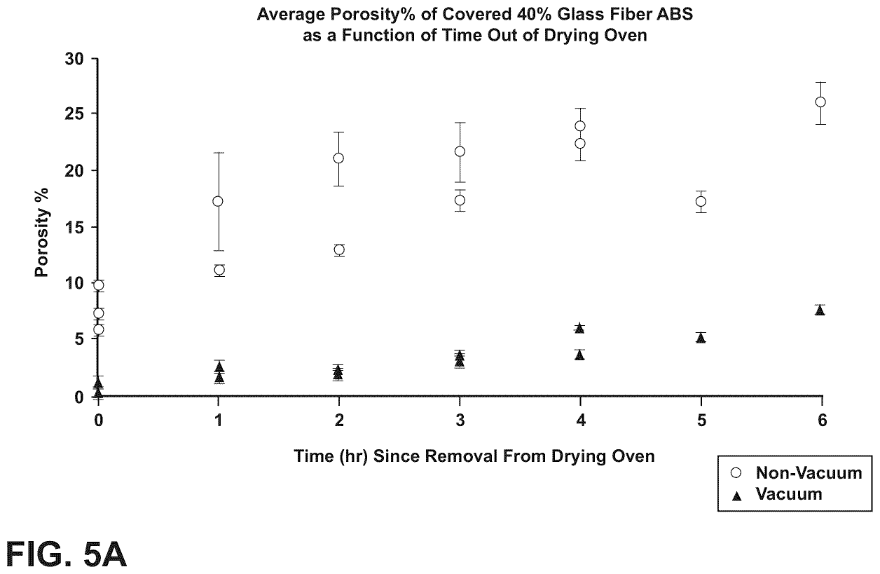

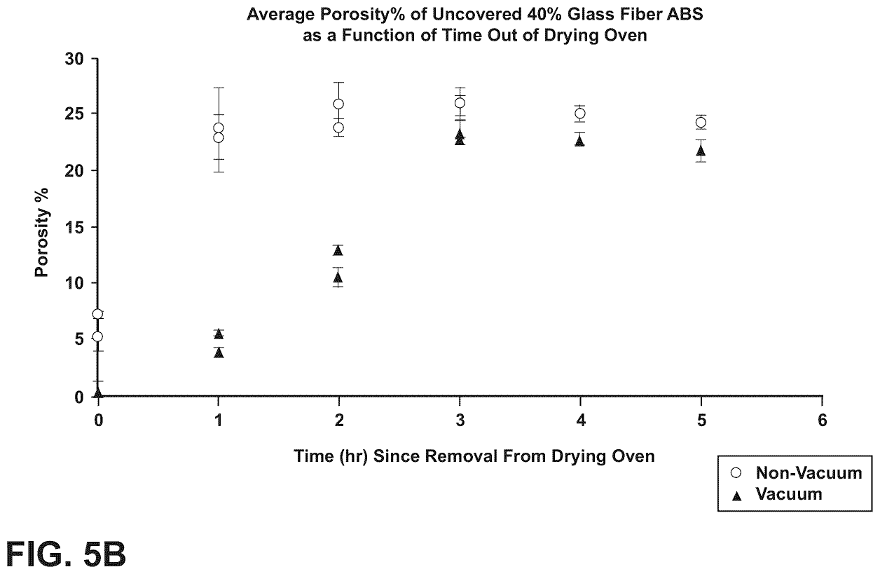

Pellets were dried thoroughly and transferred to the pellet hopper in small batches, and the printing process was initiated within minutes. 40 wt. % glass fiber-ABS pellets were removed from a drying oven and left in container, covered or uncovered, for varying amounts of time before printing. Referring now to FIG. 5A, porosity of printed glass fiber ABS is plotted as a function of time (in hours) since the removal of the 40 wt. % glass fiber ABS feedstock pellets. The feedstock pellets were stored in a covered container. Using a conventional hopper method, the porosity of samples that were immediately transitioned to the extruder was 5 to 10%. Where the pellets were stored in a covered container, the corresponding samples had an increased porosity of 20 to 25 wt. % within 3 to 4 hours. When a vacuum was applied, the porosity of the samples was reduced to below 5% for feedstock stored in a covered container for three hours or less, but the porosity of samples steadily increased to 8% for feedstock stored for six hours. As depicted in FIG. 5A, the application of a vacuum significantly reduces porosity of samples compared to non-vacuum samples for feedstock stored for the same length of time.

Referring now to FIG. 5B, porosity of printed glass fiber ABS is plotted as a function of time (in hours) since the removal of the 40 wt. % glass fiber ABS feedstock pellets. The feedstock pellets were stored in an uncovered container. FIG. 5B shows that samples exposed to ambient conditions for even 1 hour had porosity on the order of 25% when using a conventional feed hopper and method. The porosity held relatively constant for exposure times approaching 6 hours. The vacuum method and feed hopper were very effective at reducing the porosity of the corresponding samples after exposure times of 1 to 2 hours, but there was relatively little impact of the vacuum hopper system after 3 hours or more of exposure.

Without seeking to be bound by any theory, it is believed that the vacuum feed hopper was more effective at reducing porosity during the shorter exposure times because moisture was largely concentrated on the surface of the pellets and was driven out of the material early in the extrusion process when the negative pressure in the pellet hopper extracted moisture from the system. In samples exposed to ambient conditions for longer time periods, moisture likely penetrated deeper into the core of the pellets and did not vaporize until later in the extrusion process when the feedstock was no longer subject to the effects of the vacuum upstream. A further reason for the leveling off of the maximum porosity within the samples was that during extrusion the bead would steam at higher moisture levels. The steaming indicates that at a certain threshold of moisture the pressure difference between the water vapor inside the material and the ambient atmospheric pressure would allow the moisture to rapidly escape the molten feedstock before it had a chance to solidify and trap the remaining vapor. In embodiments where the feedstock is left for long periods of time in an uncovered container after drying, any positive reductions in porosity from the vacuum is overwhelmed by the volume of vapor formed.

A larger-scale Strangpresse single-screw extruder (model 30) is used on the AMCM system. The extruder was a vertically-oriented single screw extruder with a 30 mm diameter screw that was 914.4 mm long. A 2.1-liter prismatic pellet hopper was positioned above and slightly offset from the screw axis. Pellets were gravity-fed through a port in the side of the barrel using a 25.4 mm diameter angled tube. The extruder used four temperature control zones along a length of the screw set to 180° C. (feed section), 220° C. (mixing section), 240° C. (metering section), and 240° C. (nozzle). At an end of the screw, the material exits vertically through a 10.16 mm diameter nozzle. The screw rotational speed was tested at 400 rpm and 800 rpm. A lid designed especially for the Strangpresse hopper including a vacuum port and pressure gauge. The single-screw extruder was fun until consistent flow was established, the vacuum lid was placed on top of the feed hopper, and a vacuum pump (CPS model VP4D, 96 L/min) was turned on, and a rough vacuum of −254 to −381 Torr (−10 to −15 in Hg) was achieved in the hopper within 2 to 3 minutes under constant extrusion. Extruded samples were vertically suspended in around 500 to 600 mm sections before being trimmed at the nozzle exit and transitioned to a horizontal tray for cooling.

Experiments were conducted on the Strangpresse single-screw extruder to evaluate the effectiveness of the vacuum hopper method to large format additive manufacturing (LFAM). The method used on the Randcastle extruder was repeated using the Strangpresse extruder except the vacuum applied to the Strangpresse system was limited to −10 to −15 in Hg (−266 to −380 Torr and 35 to 50% vacuum). Even with a lower level vacuum applied to the hopper, the vacuum hopper was still effective at reducing the porosity at two different screw speeds for 20 wt. % carbon fiber ABS The vacuum hopper method reduced the porosity at the higher screw speed (800 rpm) by almost 50%, from 6.9% to 3.7%. The vacuum hopper method is effective at reducing porosity across multiple scale platforms and can be applied to LFAM printing systems.

TABLE 1
Porosity % Improvement of 20 wt. % Carbon
Fiber ABS on Stangpresse System Extruder

| | | Average | Standard Deviation | |
|---|---|---|---|---|
| RPM | Vacuum? | Porosity % | Porosity % | Improvement % |
| 400 | No | 5.29 | 0.52 | 25.2 |
| | Yes | 3.96 | 0.62 | |
| 800 | No | 6.85 | 0.45 | 45.9 |
| | Yes | 3.70 | 0.79 | |

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. If not otherwise defined herein, “about” is defined as within ±25%, alternatively ±10%, or alternatively ±5%.

1. A method of additively manufacturing reduced porosity composites, the method comprising the steps of:
providing an additive manufacturing printer comprising a feed hopper, the feed hopper comprising:
a first hopper wall defining a feed inlet and a chamber opening;
a second hopper wall contacting an outlet end of the first hopper wall and defining a feed outlet;
a vacuum lid contacting a feed end of the first hopper wall;
a first valve disposed proximate the feed inlet in a closed position;
a second valve disposed proximate the chamber opening in an open position; and
a vacuum pump;
wherein the first hopper wall and the vacuum lid define a first chamber disposed proximate to a second chamber defined by the first hopper wall and the second hopper wall; and
wherein the first chamber and the second chamber are in selective fluid communication via the chamber opening;
applying a rough vacuum to the first chamber and the second chamber using the vacuum pump;
feeding feedstock into the feed hopper of the additive manufacturing printer;
opening the first valve and closing the second valve, thereby pulling feedstock into the first chamber from a feedstock source;
closing the first valve and opening the second valve, thereby allowing feedstock from the first chamber to enter the second chamber and maintain a rough vacuum in the second chamber;
allowing the feedstock to exit the feed hopper via the feed outlet;
heating the feedstock to give a heated printing material; and
extruding the heated printing material out of the additive manufacturing printer.

2. The method of claim 1, wherein the method further comprises the step of drying the feedstock at a drying temperature for a drying time.

3. The method of claim 2, wherein the step of drying the feedstock occurs less than 6 hours before the step of extruding the feedstock out of the additive manufacturing printer.

4. The method of claim 2, wherein the drying temperature is a temperature of between 40 to 120° C. and the drying time is between 2 and 12 hours.

5. The method of claim 1, wherein the feedstock comprises a reinforcing fiber.

6. The method of claim 5, wherein the reinforcing fiber comprises a carbon fiber or a glass fiber.

7. The method of claim 6, wherein the feedstock comprises a carbon fiber in an amount of from 0.01 to 25 wt. %.

8. The method of claim 6, wherein the feedstock comprises a glass fiber in an amount of from 0.01 to 45 wt. %.

9. The method of claim 1, wherein the step of heating the feedstock further comprises displacing the feedstock through multiple temperature control zones.

10. The method of claim 9, wherein the feedstock is displaced through four temperature control zones, the temperature control zones consisting of:
a feed heating section having a feed temperature;
a mixing section having a mixing temperature;
a metering section having a metering temperature; and
an exit section having an exit temperature.

11. The method of claim 10, wherein:
the feed temperature is a temperature of between 150 to 210° C.;
the mixing temperature is a temperature of between 190 to 250° C.;
the metering temperature is a temperature of between 210 to 270° C.; and
the exit temperature is a temperature of between 210 to 270° C.

12. The method of claim 1, wherein the rough vacuum is a vacuum of between −200 to −760 Torr.

13. The method of claim 1, wherein the additive manufacturing printer is a single screw extruder having a screw speed of between 20 to 140 rpm or between 200 to 1000 rpm during the step of extruding the heated printing material out of the additive manufacturing printer.

14. An additively manufactured article manufactured by the method of claim 1.

15. A feed hopper for an extruder for the extrusion of low porosity additively manufactured composites, the feed hopper comprising:
a first hopper wall defining a feed inlet and a chamber opening;
a second hopper wall contacting an outlet end of the first hopper wall and defining a feed outlet;
a vacuum lid contacting a feed end of the first hopper wall;
a first valve disposed proximate the feed inlet;
a second valve disposed proximate the chamber opening; and
a vacuum pump;
wherein the first hopper wall and the vacuum lid define a first chamber disposed proximate to a second chamber defined by the first hopper wall and the second hopper wall; and
wherein the first chamber and the second chamber are in selective fluid communication via the chamber opening.

16. The feed hopper of claim 15, wherein the feed hopper further comprises a sensor disposed proximate the second hopper wall, configured to detect a level of feedstock.

17. The feed hopper of claim 16, wherein the sensor is a light sensor.

18. A method of additively manufacturing reduced porosity composites, the method comprising the steps of:
applying a rough vacuum to a first chamber and a second chamber defined by a feed hopper of an additive manufacturing printer;
feeding feedstock into the feed hopper of the additive manufacturing printer;
allowing the feedstock to exit the feed hopper via the feed outlet;
heating the feedstock to give a heated printing material; and
extruding the heated printing material out of the additive manufacturing printer.

19. The method of claim 18, wherein the rough vacuum is a vacuum of between −200 to −760 Torr.

20. The method of claim 18, wherein the method further comprises the step of drying the feedstock at a drying temperature for a drying time.
